(19) United States
(12) Patent Application Publication
(10) Pub. No.: US 2006/0017621 A1
(43) Pub. Date: Jan. 26, 2006

(54) Antenna

(75) Inventors: Kazuhiko Okawara, Shizuoka (JP); Hiroyuki Okabe, Shizuoka (JP)

Correspondence Address: HARNESS, DICKEY & PIERCE, P.L.C., P.O. BOX 828, BLOOMFIELD HILLS, MI, 48303, US

(73) Assignee: FDK Corporation, Tokyo (JP)

(21) Appl. No.: 11/183,042

(22) Filed: Jul. 15, 2005

Related U.S. Application Data
(63) Continuation of application No. PCT/JP04/00244, filed on Jan. 15, 2004.

(30) Foreign Application Priority Data
Jan. 15, 2003 (JP) 2003-007257

(51) Int. Cl. H01Q 1/38

(52) U.S. Cl. 343/700 MS; 343/702

(57) ABSTRACT

The transmit/receive antenna has an active element with a two-dimensional conductor pattern formed on the surface of a dielectric substrate, surface-surface mounted to a PC board, and forming plural distribution paths of mutually different length. Antenna current is copied into a ground conductor such that the antenna element defines a linear main radiator, having a feeding end and an open end, forming a first distribution path, and a linear short-circuiting branching T-conductor, forming a second distribution path. A third distribution path is formed across the main radiation conductor leading to the ground conductor. This configuration produces two resonance frequency bands, exclusive of harmonics. The main radiation conductor and the feeding conductor are formed by conductor patterns on the dielectric substrate and the short-circuiting conductor is formed by a conductor pattern over the upper surface and side surface of the dielectric.

### CROSS-REFERENCE TO RELATED APPLICATIONS

This application is a continuation of the International Application No. PCT/JP20041000244 tiled on Jan. 15, 2004 designating the United States of America.

### BACKGROUND OF THE INVENTION

1. Field of the Invention

The present invention relates to a multi-frequency transmit and/or receive antenna having a single feeder and a plurality of resonance frequency bands, and particularly to an antenna for ultra high frequencies in or higher than a microwave range, which can be used in small radio communication apparatuses such as mobile communication apparatuses, a radio LAN (Local Area Network), an ITS (Intelligent Transport System), an ETC (Electronic Toll Collection System), and a GPS (Global Positioning System).

2. Description of the Related Art

Such antennas can be classified into two main types: a traveling-wave type (non-resonance type) wherein radio signal waves are made to travel through a radiation conductor configured to have an equivalently infinite length or spread as seen from the power feeding side, and a resonance type wherein a radio signal is made to resonate along a radiation conductor configured to have a predetermined length or spread. The former theoretically has a wideband and is suitable for use as a multi-band antenna, but since having to be configured to have an equivalently infinite length, it is difficult to miniaturize the antenna. For the latter, since its band of frequencies at which to be able to resonate depends on the length, shape, and the like of the radiation conductor, it is difficult to widen the band, but is suitable for being configured to be small in size and low in cost. Hence, the latter is mainly used in the small radio communication apparatuses such as in radio LANS and GPSs.

The resonance-type antenna can be made to have multiple bands (multiple frequencies) through harmonic resonance, but in this case, the frequencies are limited to those of a fundamental wave and harmonics, which are in a relationship of a ratio of integers with each other. In order to make the antenna have multiple bands (multiple frequencies) without using harmonics, the antenna need be configured such that the distribution path for the antenna current (antenna resonant current) excited by the feeding is formed to be different in length for each of a plurality of bands, That is, antenna resonance circuits need be formed in plurality.

Among this type of antennas are those described in Japanese Patent Laid-Open Publications No. 6-232625, No. 9-219619, No. 2000-68736, No. 2000-68737, No. 2001-144524, and No. 2001-251128.

However, there are the following problems with the above conventional antennas. For example, those described in Japanese Patent Laid-Open Publications No. 2000-68737 and No. 2001-144524 need to have a spatial (three-dimensional) structure, and hence, it is difficult to miniaturize the antenna due to the complexity of the configuration and also to lower the cost is difficult due to lowness of suitability for manufacture, especially mass productivity. The antenna of Japanese Patent Laid-Open Publication No. 6-232625 is relatively simple in shape, but since having a spatial structure like the above, is not suitable for lowering cost. Furthermore, because of its configuration wherein a plurality of radiation conductors having a wide area are positioned above and Opposite each other, radiation efficiency is likely to be reduced.

In contrast, those described in Japanese Patent Laid-Open Publications No. 2000-68736, No. 9-219619, and No. 2001-251128 can be made up of conductor patterns formed two-dimensionally on surfaces of substrates without a need for a spatial structure, and hence are suitable for mass manufacture for the simplicity of the structure. However, although the feeding is performed through one common place, radiation conductors to be excited by the feeding are provided independently for respective frequency bands. That is, it is substantially the same as the configuration with only the feeder for a plurality of antenna elements being common. It takes a large area to form a plurality of conductor patterns that form radiation conductors to resonate independently at their respective frequencies, and thus it is difficult to miniaturize the antenna .

Note that for relatively low frequency ranges such as HE (short waves) and VHF (ultra short waves), a multi-band antenna may be used wherein with a frequency trap constituted by an LC lumped constant inserted in series at a position along a linear conductor forming an antenna element, the resonance length of the linear conductor is variable according to the frequency band. However, although this technology is effective for antennas for relatively long wavelengths such as HF and VHF, it is not appropriate to apply to antennas for ultra high frequency ranges mainly using a distributed constant. Even if possible, the structure will become very complex and not miniature and low in cost.

### SUMMARY OF THE INVENTION

This invention was made in view of the above problems, an object thereof is to provide an antenna wherein an antenna element that can resonate at a plurality of frequency bands can be configured easily and at low cost with not a complex, high-cost spatial structure but a conductor pattern formed two-dimensionally along a surface of a substrate, wherein the sizes, especially length, of the conductor pattern needed in the configuration can be made smaller, and wherein in spite of the structure being suitable for being miniaturized and lowering cost, good electric characteristics are achieved for a plurality of frequency bands other than those of harmonics.

According to an aspect of the present invention, there is provided an antenna for transmission and/or receipt having a single feeder wherein an active antenna element, in which an antenna current excited by feeding is distributed in a line to radiate electromagnetic waves, is comprised of a conductor pattern formed two-dimensionally along surfaces of a substrate, and configured such that a distribution path for the antenna current is formed to be different in length for each of a plurality of cases, characterized in that the antenna element constitutes a grounded-type antenna in which the antenna current is copied in a ground conductor, and comprises a linear main radiation conductor, of which one end is a feeding end and an other end on the opposite side is an open end, and a linear short-circuiting conductor branching off at a position along the main radiation conductor in the shape of T and leading to the ground conductor, and in that the distribution path for the antenna current is formed to be among at least two of a first path from the one end to the other end of the main radiation conductor, a second path from the one end of the main radiation conductor through the T-shaped branch to the ground conductor, and a third path leading to and turning back at the other end of the main radiation conductor and leading to the ground conductor, and thereby the antenna has at least two resonance frequency bands other than those of harmonics.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a perspective view illustrating a main portion of an antenna according to a first example of the present invention;

FIG. 2 is a perspective view illustrating the whole including the periphery of the antenna of FIG. 1;

FIG. 3 is a conceptual diagram showing current paths when the antenna according to the present invention operates;

FIG. 4 is a graph showing a first example of a VSWR-frequency characteristic achieved by the antenna according to the present invention;

FIG. 5 is a graph showing a second example of the VSWR-frequency characteristic achieved by the antenna according to the present invention;

FIG. 6 is a graph showing an example of the directivity achieved by the antenna according to the present invention, particularly, the antenna directivity along a Z-X plane for a lower frequency band;

FIG. 7 is a graph showing an example of the directivity achieved by the antenna according to the present invention, particularly, the antenna directivity along a Z-Y plane for the lower frequency band;

FIG. 8 is a graph showing an example of the directivity achieved by the antenna according to the present invention, particularly, the antenna directivity along an X-Y plane for the lower frequency band;

FIG. 9 is a graph showing an example of the directivity achieved by the antenna according to the present invention, particularly, the antenna directivity along the Z-X plane for a higher frequency band;

FIG. 10 is a graph showing an example of the directivity achieved by the antenna according to the present invention, particularly, the antenna directivity along the Z-Y plane for the higher frequency band;

FIG. 11 is a graph showing an example of the directivity achieved by the antenna according to the present invention, particularly, the antenna directivity along the X-Y plane for the higher frequency band;

FIG. 12 is a perspective view illustrating a second example of the antenna according to the present invention;

FIG. 13 is a perspective view illustrating a third example of the antenna according to the present invention; and

FIG. 14 is a perspective view illustrating a fourth example of the antenna according to the present invention.

### DETAILED DESCRIPTION OF THE INVENTION

At least the following matters will be made clear through the present specification and the description of the accompanying drawings.

The present invention is an antenna for transmission and/or receipt having a single feeder comprising an active antenna element in which an antenna current excited by feeding is distributed in a line to radiate electromagnetic waves, said active antenna element having a conductor pattern formed two-dimensionally on surfaces of a dielectric substrate made of a dielectric of a high dielectric constant and low loss and surface-mounted as a chip component on a print circuit board, said antenna element being configured such that a plurality of distribution paths for the antenna current are formed to be different in length to each other, wherein said antenna element constitutes a grounded-type antenna in which said antenna current is copied in a ground conductor, and comprises a linear main radiation conductor, of which one end is a feeding end and an other end on the opposite side is an open end, and a linear short-circuiting conductor branching off at a position along said main radiation conductor in the shape of T and leading to said ground conductor; wherein the distribution path for said antenna current is formed to be among at least two of a first path from the one end to the other end of said main radiation conductor, a second path from he one end of said main radiation conductor through said T-shaped branch to said ground conductor, and a third path leading to and turning back at the other end of said main radiation conductor and leading to said ground conductor, and thereby said antenna has at least two resonance frequency bands other than those of harmonics; and wherein said antenna element is in the form of a surface-mounted chip component formed with said dielectric substrate, and said main radiation conductor and a feeding conductor at one end thereof together are formed by conductor patterns formed on said dielectric substrate, and said short-circuiting conductor is formed by a conductor pattern formed over an upper surface and side surface of said dielectric substrate.

By the above configuration, an antenna element that can resonate at a plurality of frequency bands can be configured easily and at low cost with not a complex, high-cost spatial structure but a conductor pattern formed two-dimensionally along a surface of a substrate, and the sizes, especially length, of the conductor pattern needed in the configuration can be made smaller, and in spite of the structure being suitable for being miniaturized and lowering cost, good electric characteristics can be achieved for a plurality of frequency bands other than those of harmonics.

According to the present invention, by placing in series a capacitor formed by a gap of the conductor patterns between a feeding conductor to feed a current through and the feeding end of the radiation conductor, a feeding coupling can be easily formed.

Furthermore, the distribution path for the antenna current is formed in the three ways, the above first to third paths, and thereby three resonance frequency bands other than those of harmonics can be achieved. Moreover, by making two or more resonance frequencies achieved by any two or more of the above first to third paths, or their harmonic resonance frequencies, close to each other, a wideband characteristic can be achieved.

Also, the size of the whole or part of the above active antenna element can be reduced by an effect due to inserting a capacitance component, an inductance component, or a dielectric. Furthermore, the present invention provides a miniaturized, low cost, high performance radio communication apparatus when the antenna having the above means is provided therein.

Features and objects of the present invention other than the above will become clear by reading the description of the present specification with reference to the accompanying drawings.

### ONE EMBODIMENT OF THE PRESENT INVENTION

Typical examples of the present invention will be described below. Note that although the antenna is used for transmission and/or receipt, following the convention of this technology field, a description will be made as being a transmission antenna.

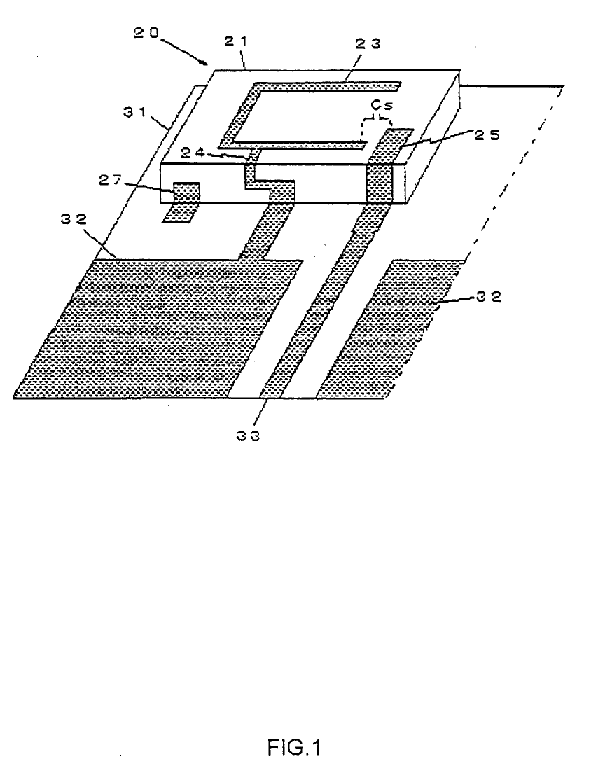

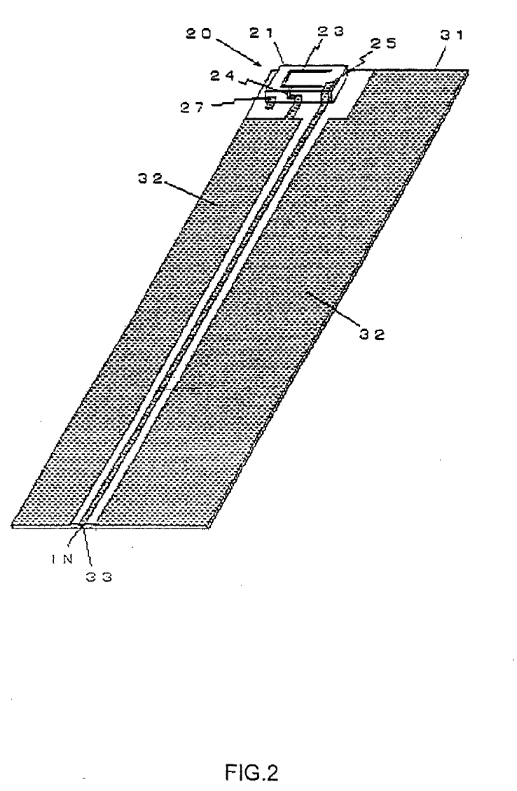

FIGS. 1 and 2 illustrate a first example of the antenna to which the technology of the present invention has been applied. FIG. 1 is a magnified view of the main portion of the antenna 20, and FIG. 2 is a view of the whole antenna inc luding the periphery.

The antenna 20 shown in the Figures comprises a dielectric substrate 21 surface-mounted on a corner of a print circuit board 31. The dielectric substrate 21 is made of a dielectric having a high dielectric constant and low loss and is surface-mounted as a kind of chip component (SMD) on the print circuit board 31. To describe more specifically, in this example, used as the dielectric substrate 21 is a dielectric substrate having a relative permittivity Σr=20 and a size of 10.0×4.5×1.5 mm. And, used as the print circuit board 31 is a glass epoxy board having a size of 125.0×35.0×0.8 mm. This print circuit board 31 is a board having conductors (Cu) over both surfaces, and has formed thereon a micro strip line of about 50 Ω in characteristic impedance described later.

Formed on a surface of the dielectric substrate 21 are conductor patterns such as a main radiation conductor 23, a short-circuiting conductor 24, and a feeding conductor 25. In this case, the conductor patterns of the main radiation conductor 23 and the feeding conductor 25 are formed on only the upper surface of the substrate 21, and the conductor pattern of the short-circuiting conductor 24 is formed over the upper surface and a side of the substrate 21. Also, a conductor pattern that is a terminal 27 for soldering for surface-mounting is formed on the lower portion of the side of the substrate 21. The above conductor patterns are all formed two-dimensionally along the surfaces of the substrate 21 in the torm of print wiring or the like.

Formed on the upper surface of the print circuit board 31 having the dielectric substrate 21 surface-mounted thereon are a mat-like conductor pattern forming a ground conductor 32 and a micro strip line (50 Ω) forming a transmission line 33. The transmission line 33 connects a signal input/output terminal IN and the feeding conductor 25. The transmission line 33 is connected to the feeding conductor 25 via a conductor pattern formed over the side surface and upper surface of the substrate 21.

The feeding conductor 25 is arranged near one end of the main radiation conductor 23. A gap is present between both the conductors 23, 25, and a predetermined capacitance Cs formed with the gap is inserted in series between both the conductors 23, 25, and thus both the conductors 23, 25 are coupled by the capacitance Cs.

The main radiation conductor 23 and the short-circuiting conductor 24 form the main portion of the antenna element in which an antenna current (antenna resonance current) excited is distributed in a line. The antenna element constitutes a grounded-type antenna in which the antenna current is copied in the ground conductor 32. The grounded-type antenna is an antenna that achieves a predetermined antenna characteristic with an actual antenna element excited by feeding and an image antenna element formed by imaging in the ground conductor 32. For example, a grounded-type antenna of ¼ wavelength achieves an antenna characteristic of an effective length (½ wavelength) equivalently twice that by having an image antenna element of the same ¼ wavelength imaged in the ground conductor. In order to have such an image antenna formed, the ground conductors 32 are formed all over the board except the lower surface of the substrate 21 and the areas next thereto.

The main radiation conductor 23 is formed by a linear conductor pattern of a predetermined length winding (or turning) on the upper surface of the dielectric substrate 21. One end of the main radiation conductor 23 is its feeding end, which is coupled to the feeding conductor 25 via the apacitance Cs, and the other end is an open end. The short-ircuiting conductor 24 is formed by a linear conductor pattern and branches off at a position along the main radiation conductor 23 in the shape of T and leads to the ground conductor 32.

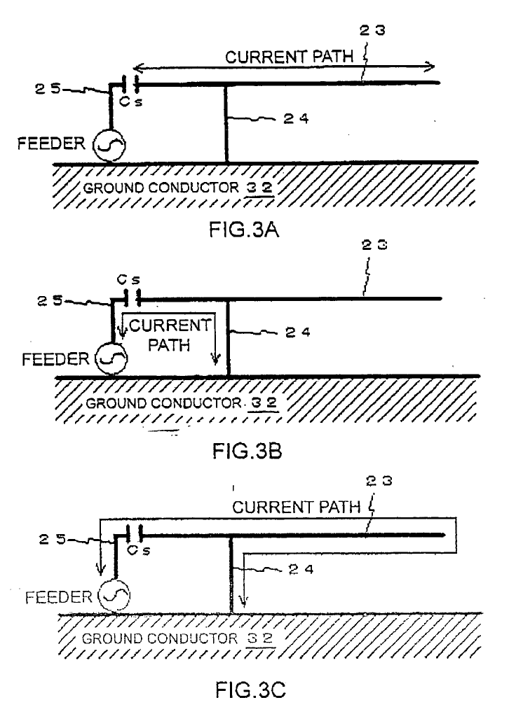

FIG. 3 shows equivalent circuit diagrams of the antenna 20. The antenna 20 is excited by feeding via the capacitance Cs at the one end of the main radiation conductor 23. The antenna current caused by the excitation is distributed along three paths indicated by the arrows in FIGS. 3A, 3E, 3C.

The first path is, as shown in FIG. 3A, from the one end to the other end of the main radiation conductor 23, along which the antenna current is distributed. In this case, in the antenna 20, the current resonates in a current distribution where the current is a minimum (and the voltage is a maximum) at the other end (open end) of the main radiation conductor 23. in other words, the current resonates at such a wavelength (frequency band) as causes that current distribution.

The second path is, as shown in FIG. 3B, from the one end of the main radiation conductor 23 through the T-shaped branch up to the ground conductor 32, along which the antenna current is distributed. In this case, along this second path in the antenna 20, the current resonates in a current distribution where the current is a maximum (and the voltage is a minimum) at the end (ground end) of the shortcircuiting conductor 24. In other words, the current resonates at such a wavelength (frequency band) as causes that current distribution.

The third path is, as shown in FIG. 3C, leading to and turning back at the other end of the main radiation conductor 23 and leading to the ground conductor 32, along which the antenna current is distributed. In this case, along this third path in the antenna 20, the current resonates in a current distribution where the current is a maximum (and the voltage is a minimum) at the end (ground end) of the short-circuiting conductor 24. In other words, the current resonates at such a wavelength (frequency band) as causes that current distribution.

The resonance frequencies for the first to third paths can be set arbitrarily by using as parameters the length of the main radiation conductor 23, the position of the T-shaped branch, and the length of the short-circuiting conductor 24. Thus, the antenna is configured to have three resonance frequency bands other than those of harmonics.

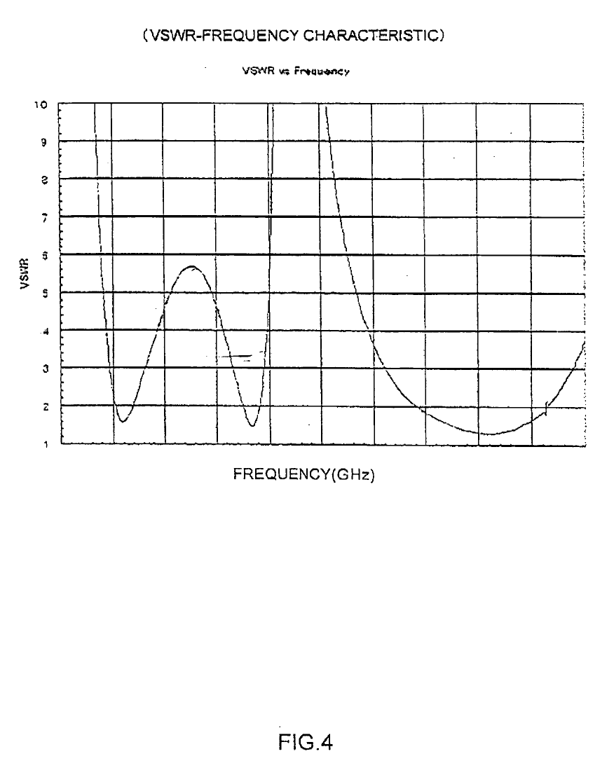

FIG. 4 shows a first example of a VSWR-frequency characteristic achieved by the above antenna. In the example of the Figure, VSWR (standing wave ratio) is a minimum (VSWR<2) at three different frequency bands. Thus, in this case, a multi-band antenna usable for the three frequency bands is realized. That is, the distribution path of the antenna current is formed in the three ways, the above first to third paths, and the antenna 20 resonates along the effective length of each of the paths Thus, the antenna is configured to have three resonance frequency bands other than those of harmonics.

PIG. 5 shows a second example of a VSWR-frequency characteristic achieved by the above antenna. In the example of the Figure, there are two frequency bands at which VSWR (standing wave ratio) is a minimum (VSWR<2), but the width of one frequency band (for which VSWR<2) is very wide. This is because two adjacent ones of the three resonance frequency bands are made closer to each other to be continuous.

As above, according to the antenna 20 of the present invention, the distribution path for the antenna current is formed in the three ways, the first to third paths, and thereby three resonance frequency bands other than those of harmonics can be achieved. However, by making two or more resonance frequency bands of the three closer to each other, a very wide band characteristic can be obtained.

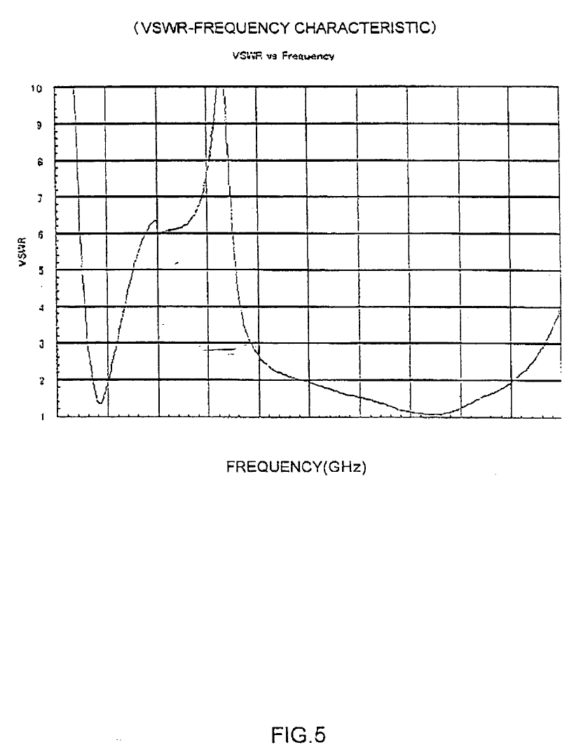

Moreover, when performing electromagnetic analysis of the above examples of the antenna 20, high radiation efficiency (greater than 90%) was obtained at each resonance frequency band. Furthermore, the percentage of the frequency band for which VSWR<2 in FIG. 5 was 6.5% for the lower band and no less than 40% for the higher band for both calculated values and measured values for a prototype.

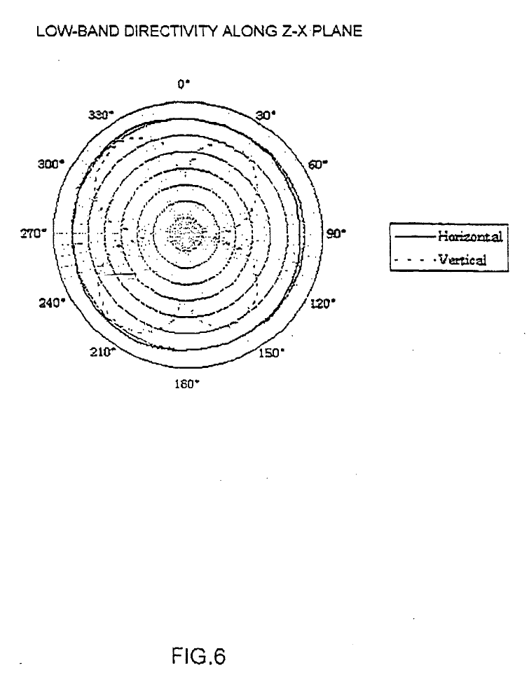

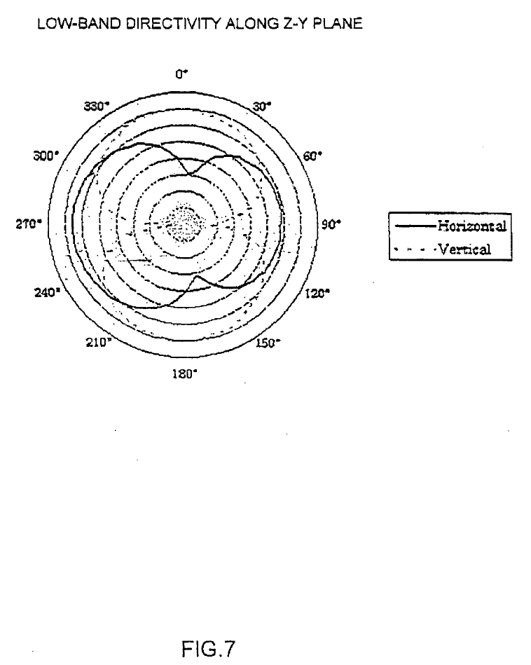

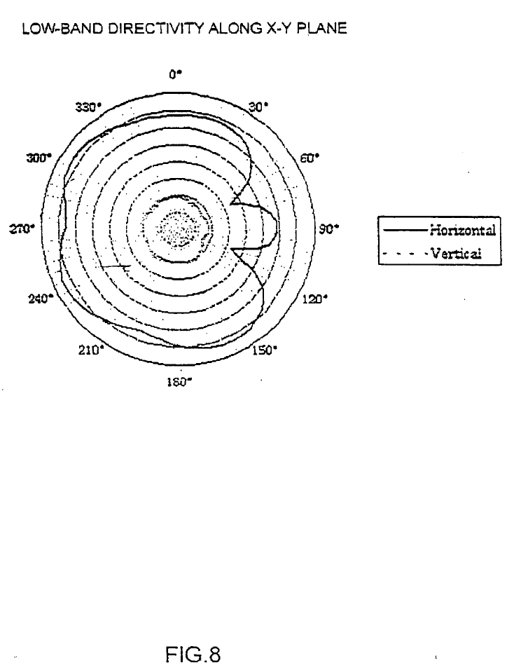

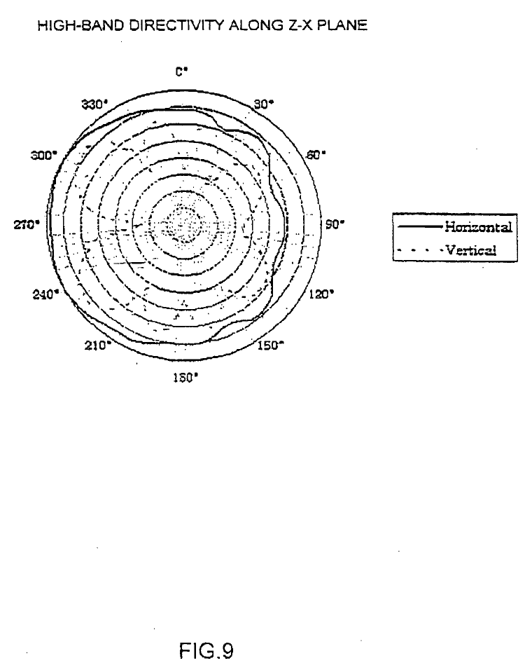

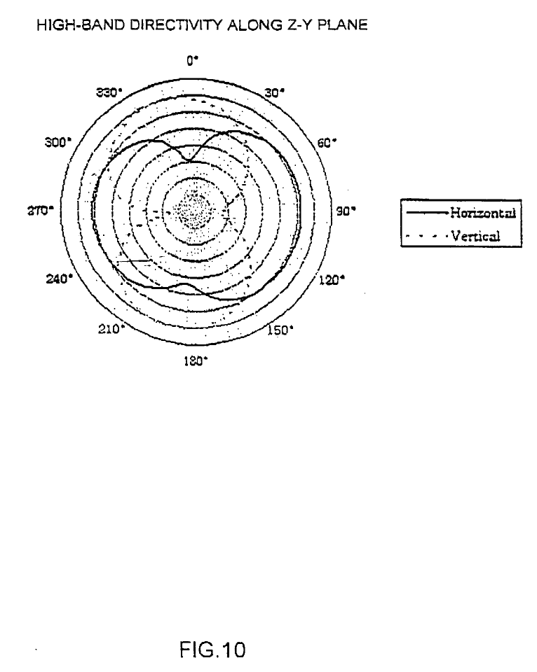

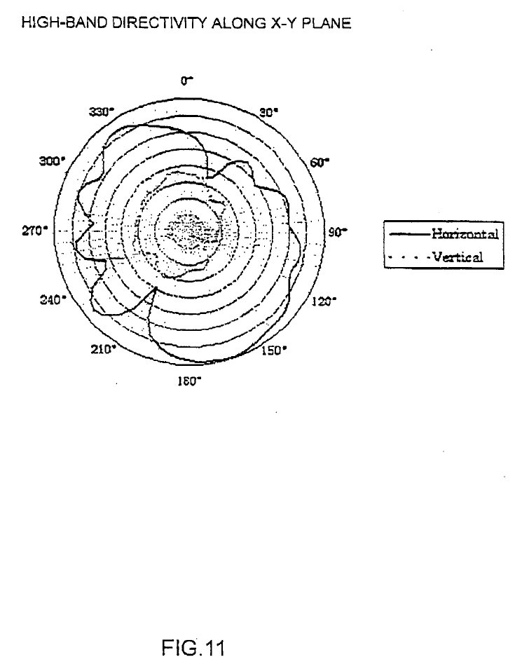

FIGS. 6 to 11 show the directivity of the above example antennas, particularly, the antenna configured to have the characteristic of FIG. 5. FIGS. 6 to 8 show the directivity for the lower band (Low-band) for each of Z-X, Z-Y, X-Y planes. FIGS. 9 to 11 show the directivity for the higher band (High-band) for each of the Z-X, Z-Y, X-Y planes. As shown in the Figures, the antenna 20 can have a good, broad directivity for both the lower and higher bands. Such a broad directivity is also convenient in designing to have a particular directivity with a passive antenna element.

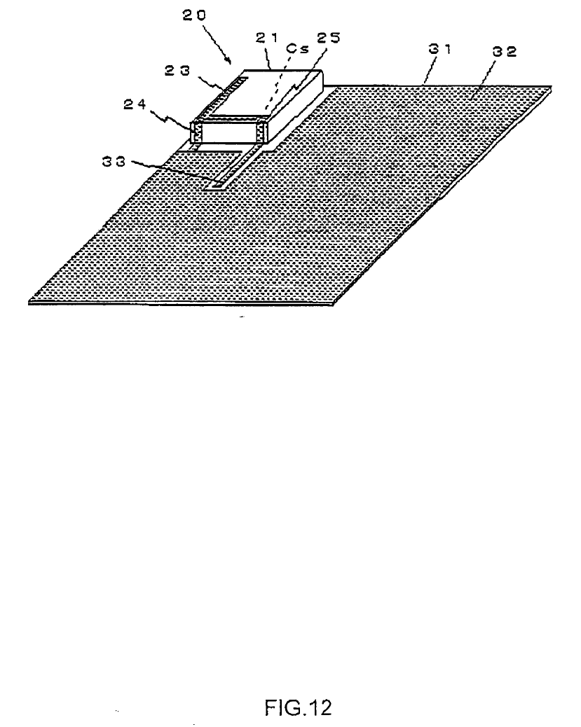

FIG. 12 shows a second example of the antenna of the present invention. The conductor patterns of the main radiation conductor 23 and the short-circuiting conductor 24 are changeable according to the sizes and shapes of the substrate 21 and the board 31 and other conditions as shown in the Figure. Moreover, as shown in the Figure, the transmission line 33, a micro strip line, for feeding through may be formed to be connected to a high frequency circuit (not shown) mounted on the circuit board 31.

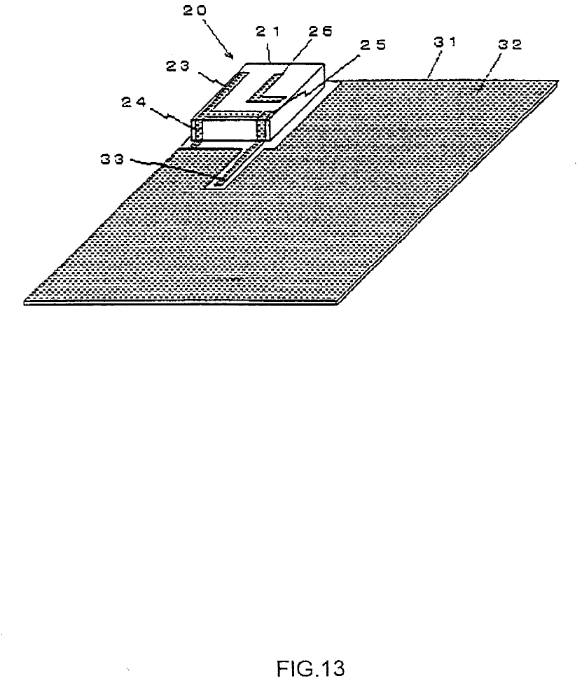

FIG. 13 shows a third example of the antenna of the present invention. The conductor pattern of a passive antenna element 26, which the feeding is not performed for, may be formed on the dielectric substrate 21 at the same time as the conductor patterns of the main radiation conductor 23, the short-circuiting conductor 24, and the like are formed as shown in the Figure. The passive antenna element 26 is effective to increase an antenna gain selectively for a particular direction or to change/adjust frequency characteristics.

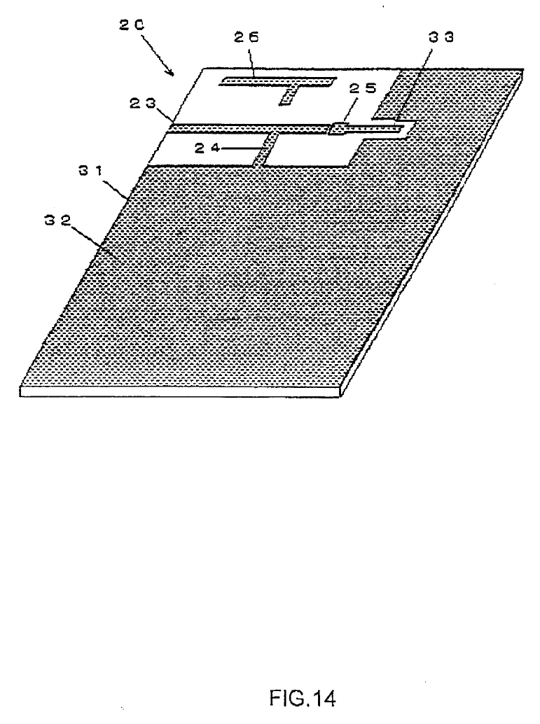

FIG. 14 shows a fourth example of the antenna of the present invention. The conductor patterns of the main radiation conductor 23, the short-circuiting conductor 24, and the like may be formed directly on the print circuit board 31 as shown in the Figure. In this case, part of the print circuit board 31 is substituted for the dielectric substrate 21.

As described above, according to the antenna 20 of the present invention, an antenna element that can resonate at a plurality of frequency bands can be configured easily and at low cost with not a complex, high-cost spatial structure but a conductor pattern formed two-dimensionally along a surface of the substrate 21, and the sizes, especially length, of the conductor pattern needed in the configuration can be made smaller, and in spite of the structure being suitable for being miniaturized and lowering cost, good electric characteristics can be achieved for a plurality of frequency bands other than those of harmonics.

Yet further, the antenna 20 of the present invention being based in structure on the grounded-type antenna contributes to miniaturization thereof, and in addition, the whole or part of the conductor pattern of the active antenna element, formed by the main radiation conductor 23 and the short-circuiting conductor 24, can be reduced in sizes, particularly length, by an effect due to inserting a capacitance component, an inductance component, or a dielectric, and thus the antenna 20 can be further miniaturized.

In the above embodiments, the conductor patterns of the main radiation conductor 23 and the short-circuiting conductor 24, the feeding conductor 25, and the like can be made of a conductor such as gold, silver, and copper by using print, plating, vapor deposition, sputter, etching, and the like.

According to the present invention, an antenna element that can resonate at a plurality of frequency bands can be configured easily and at low cost with not a complex, high-cost spatial structure but a conductor pattern formed two-dimensionally along a surface of the substrate 21, and the sizes, especially length, of the conductor pattern needed in the configuration can be made smaller, and in spite of the structure being suitable for being miniaturized and lowering cost, an antenna of good electric characteristics for a plurality of frequency bands other than those of harmonics can be obtained.

What is claimed is:

1. An antenna for transmission and/or receipt having a single feeder comprising:
an active antenna element in which an antenna current excited by feeding is distributed in a line to radiate electromagnetic waves, said active antenna element having a conductor pattern formed two-dimensionally on surfaces of a dielectric substrate made of a dielectric of a high dielectric constant and low loss and surface-mounted as a chip component on a print circuit board, said antenna element being configured such that a plurality of distribution paths for the antenna current are formed to be different in length to each other,
wherein said antenna element constitutes a grounded-type antenna in which said antenna current is copied in a around conductor, and comprises a linear main radiation conductor, of which one end is a feeding end and an other end on the opposite side is an open end, and a linear short-circuiting conductor branching off at a position along said main radiation conductor in the shape of T and leadina to said ground conductor;
wherein the distribution path for said antenna current is formed to be among at least two of a first path from the one end to the other end of said main radiation conductor, a second path from the one end of said main radiation conductor through said T-shaped branch to said ground conductor, and a third path leading to and turning back at the other end of said main radiation conductor and leading to said ground conductor, and thereby said antenna has at least two resonance frequency bands other than those of harmonics; and
wherein said antenna element is in the form of a surface-ounted chip component formed with said dielectric substrate, and said main radiation conductor and a feeding conductor at one end thereof together are formed by conductor patterns formed on said dielectric substrate, and said short-circuiting conductor is formed by a conductor pattern formed over an upper surface and side surface of said dielectric substrate.

2. The antenna according to claim 1, wherein a capacitor in the form of a gap between the conductor patterns is placed in series between the feeding conductor to which a feeding current is supplied and the feeding end of said radiation conductor.

3. The antenna according to claim 1, wherein the distribution path for said antenna current is formed to be among three paths that are said first to third paths, and thereby said antenna has three resonance frequency bands other than those of harmonics.

4. The antenna according to claim 1, wherein a wideband characteristic is achieved by making closer to each other two or more resonance frequencies achieved by any two or more of said first to third paths, or harmonic resonance frequencies thereof.

5. The antenna according to claim 1, wherein the whole or part of said active antenna element is reduced in size by an effect due to placing a capacitance component, an inductance component, or a dielectric.

6. A radio communication apparatus provided with the antenna according to claim 1.
